(19) United States
(12) Patent Application Publication
(10) Pub. No.: US 2016/0286013 A1
(43) Pub. Date: Sep. 29, 2016

(54) MANAGEMENT OF STREAM METADATA DURING HIGH VOLUME REAL-TIME DATA STREAMS

(71) Applicant: General Electric Company, Schenectady, NY (US)

(72) Inventors: Stella Sheung-Ting Yu, San Ramon, CA (US); Robert Joseph Alberte, JR., Oconomowoc, WI (US); Jean Lau, San Ramon, CA (US)

(21) Appl. No.: 14/667,509

(22) Filed: Mar. 24, 2015

(51) Int. Cl. H04L 29/08; H04L 12/805

(52) U.S. Cl. CPC H04L 69/324; H04L 47/365

(57) ABSTRACT

A system comprising a computer-readable storage medium storing at least one program, and a method for managing stream metadata during high volume real-time data streams, are presented. In example embodiments, the method may include transmitting an initial data packet comprising metadata to subscribers at the beginning of a communication session. The method further includes periodically transmitting subsequent data packets comprising periodic data published by a publisher to the subscribers. Upon detection of a change in the metadata, an additional data packet comprising new metadata is transmitted to the subscribers.

### TECHNICAL FIELD

The subject matter disclosed herein relates to data processing. In particular, example embodiments may relate to management of stream metadata during high volume real-time data streams.

### BACKGROUND

In the field of software architecture, the publisher-subscriber model (also referred to as the “publish-subscribe pattern”) provides a data exchange paradigm whereby publishers provide certain types of messages to subscribers who have expressed interest in messages of that type. In the publisher-subscriber model, the publishers do not configure messages to be sent to specific subscribers, and the publishers need not have knowledge of what, if any, subscribers there may be. Instead, the subscribers simply opt in or subscribe to a certain classification of messages, and such messages are automatically provided to the subscribers upon being produced by the publishers. The classification of messages may be based on message topics, message attributes, or a combination of both.

Data that is exchanged between publishers and subscribers often has metadata (e.g., descriptive data) surrounding it. Management of metadata poses significant challenges, especially if the metadata changes. Traditionally, metadata management is handled by one of two techniques—the descriptive metadata is either never sent or the metadata is sent with every outbound data packet. The former technique can be error prone and difficult to manage from an extensibility standpoint, whereas the latter technique can be very expensive for high volume traffic in terms of network resources.

### BRIEF DESCRIPTION OF THE DRAWINGS

Various ones of the appended drawings merely illustrate example embodiments of the present inventive subject matter and cannot be considered as limiting its scope.

FIG. 1 is an architecture diagram depicting a publisher-subscriber system configured for management of metadata during high volume real-time data streams, according to an example embodiment.

FIG. 2 is an interaction diagram depicting example exchanges between a plurality of subscribers, a communication engine, and a publisher, consistent with some embodiments.

FIG. 3 is a data flow diagram illustrating an inbound flow of information to various components comprising a communication engine, which is provided as part of the publisher-subscriber system, consistent with some embodiments.

FIG. 4 is a data flow diagram illustrating an outbound flow of information from various components comprising a communication engine, which is provided as part of the publisher-subscriber system, consistent with some embodiments.

FIGS. 5A and 5B depict a flowchart of a method for managing metadata in a high volume real-time data stream, consistent with some embodiments.

FIG. 6 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Aspects of the present disclosure relate to management of metadata in high volume real-time data streams. For purposes of this disclosure, the term “metadata” (those skilled in the art may also refer to this as “descriptive data”) is used to refer to data that describes other data. Example embodiments involve metadata that describes data that is exchanged between two or more systems, such as in the publisher-subscriber model. For example, in an Extensible Markup Language (XML) protocol this would be the XML itself.

In the publisher-subscriber model, a “topic” refers to a named logical channel to which messages are published. Subscribers receive all of the messages that are published to the topics to which they subscribe. Some topics may require additional metadata to describe the data being sent. The metadata may, for example, include a data type (e.g., Integer), a unit of measure (e.g., mmHg), a scale (e.g., 10×) or various other sorts of descriptive data.

The following portion of code provides an illustrative example of the above referenced descriptive data model:

```
<DevData>
    <num>
    <InputValue BT=“xs.unsignedInt” U=“mm/s” S=“.1”/>
    <OutputValue BT=“xs:unsignedInt” U=“mm/s” S=“.1”/>
    </num>
```

As shall be appreciated from the above portion of code, the statements “xs.unsignedInt” and “xs:unsignedInt” define the data type for the input and output values, respectively. In the example of a publisher-subscriber model, these statements describe the format of the periodic data posted by the publisher. Additionally, the above code defines metadata attached to the input and output values (e.g., U=“mm/s”). In particular, the above example code defines the metadata as a unit of measure associated with the input and output values.

In the traditional publisher-subscriber paradigm, metadata is transmitted along with the data which it describes. However, high volume data that is frequently updated is often associated with metadata that may change much more infrequently. An example of the foregoing is a data stream that includes invasive blood pressure (IBP). The blood pressure itself may be 16-bit sample values occurring at 120 samples per second, but those samples may have metadata that seldom changes. For instance, an IBP value is typically associated with a physical measurement site on a patient's body, and the site for a given transducer may change a limited number of times during a measurement session. Sending this site label with each data packet (e.g., with each IBP value) is expensive in terms of computational resources. Further, methods of sending it implicitly can also be error prone and difficult to manage from an extensibility standpoint.

Unlike the traditional publisher-subscriber paradigm in which data and metadata are bundled together and communicated across one shared topic, aspects of the present disclosure address the foregoing issues, among others, by utilizing two topics—one for data and another for metadata. Further, in example embodiments, metadata is initially transmitted at the beginning of a communication session, and thereafter, the metadata is only sent again once it changes. In this manner, aspects of the present disclosure provide a novel solution for synchronizing data in high volume data exchanges that allows a system to adapt to the different natures of information while maintaining information integrity, and may thereby achieve the technical effect of increased network bandwidth efficiency.

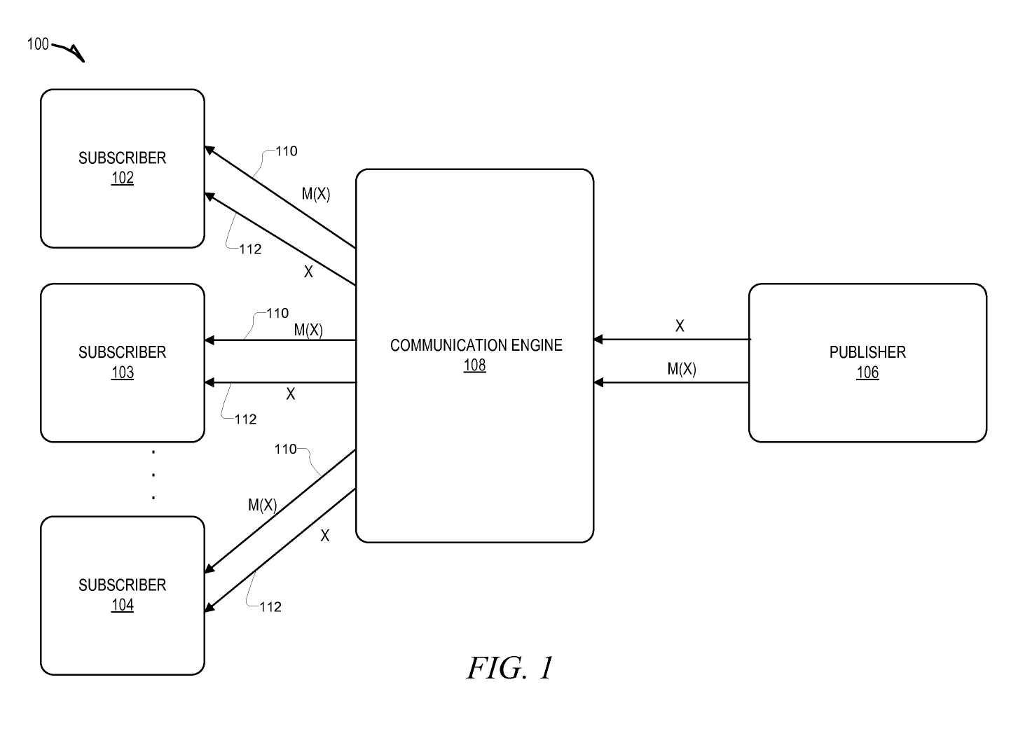

FIG. 1 is an architecture diagram depicting a publisher-subscriber system 100 configured for management of metadata during high volume real-time data streams, according to an example embodiment. As is understood by skilled artisans in the relevant computer and Internet-related arts, each component (e.g., a module or engine) illustrated in FIG. 1 represents a set of executable software instructions and the corresponding hardware (e.g., memory and processor) for executing the instructions. To avoid obscuring the inventive subject matter with unnecessary detail, various functional components (e.g., modules and engines) that are not germane to conveying an understanding of the inventive subject matter have been omitted from FIG. 1. However, a skilled artisan will readily recognize that various additional functional components may be supported by the publisher-subscriber system 100 to facilitate additional functionality that is not specifically described herein. Additionally, while a portion of the components of FIG. 1 are discussed in the singular sense, it will be appreciated that in other embodiments multiple instances of each component may be employed.

The publisher-subscriber system 100 facilitates an indirect communication between components through publishing and subscribing to messages managed by an intermediate component. The messages are data packets that typically include a subject and a structure comprising various fields and values that carry data of interest.

As shown, the publisher-subscriber system 100 includes subscribers 102-104 who may subscribe to messages of a particular topic produced by a publisher 106. The subscribers 102-104 may correspond to applications, client devices, or components of an embedded system. The publisher 106 may correspond to an application, a client device, a server computer, a database, or a component of an embedded system.

Each of the subscribers 102-104 may be communicatively coupled to a communication engine 108, which is responsible for processing subscriptions and routing messages. The subscribers 102-104 and the publisher 106 may interface with the communication engine 108 via a network, a bus, a shared memory, a switch, or application programming interfaces (APIs). In instances in which the subscribers 102-104 or the publisher 106 are coupled to the communication engine 108 via a network, the network connection may, for example, be a Wireless Fidelity (Wi-Fi, IEEE 802.11x type) connection, a Worldwide Interoperability for Microwave Access (WiMAX) connection, or another type of wireless data connection. In such an embodiment, the network may include one or more wireless access points coupled to a local area network (LAN), a wide area network (WAN), the Internet, or another packet-switched data network. In another example, the connection may be a wired connection, for example an Ethernet link, and the network may be a LAN, a WAN, the Internet, or another packet-switched data network. In yet another example, the connection may be Code Division Multiple Access (CDMA) connection, a Global System for Mobile communications (GSM) connection, or another type of cellular connection.

The subscribers 102-104 may subscribe to messages of the publisher 106 by submitting a subscription request through an interface (e.g., local or remote calls to an application program interface (API)) provided by the communication engine 108, which is responsible for synchronizing the data exchanged between the publisher 106 and the subscribers 102-104. The subscription requests specify periodic data of interest, which is denoted in FIG. 1 by “X.” The periodic data is data that is periodically published by the publisher 106. In example embodiments, the publisher 106 publishes the periodic data in real time as it is produced. The subscription requests may also identify the subscribers 102-104, publishers 106, or communication engine 108. As shown, metadata describing the periodic data, which is denoted in FIG. 1 by “M(X),” is provided to the subscribers 102-104 using a first topic 110 (e.g., a first logical channel). Additionally, the periodic data “X” is provided to the subscribers 102-104 using a second topic 112 (e.g., a second logical channel). By splitting the periodic data and metadata into two separate topics, the publisher-subscriber system 100 reduces the amount of network resources typically needed to manage such self-describing data. Further, by synchronizing the information in the two logical channels, the communication engine 108 helps to avoid errors and ambiguity in the interpretation of the data received by the subscribers 102-104.

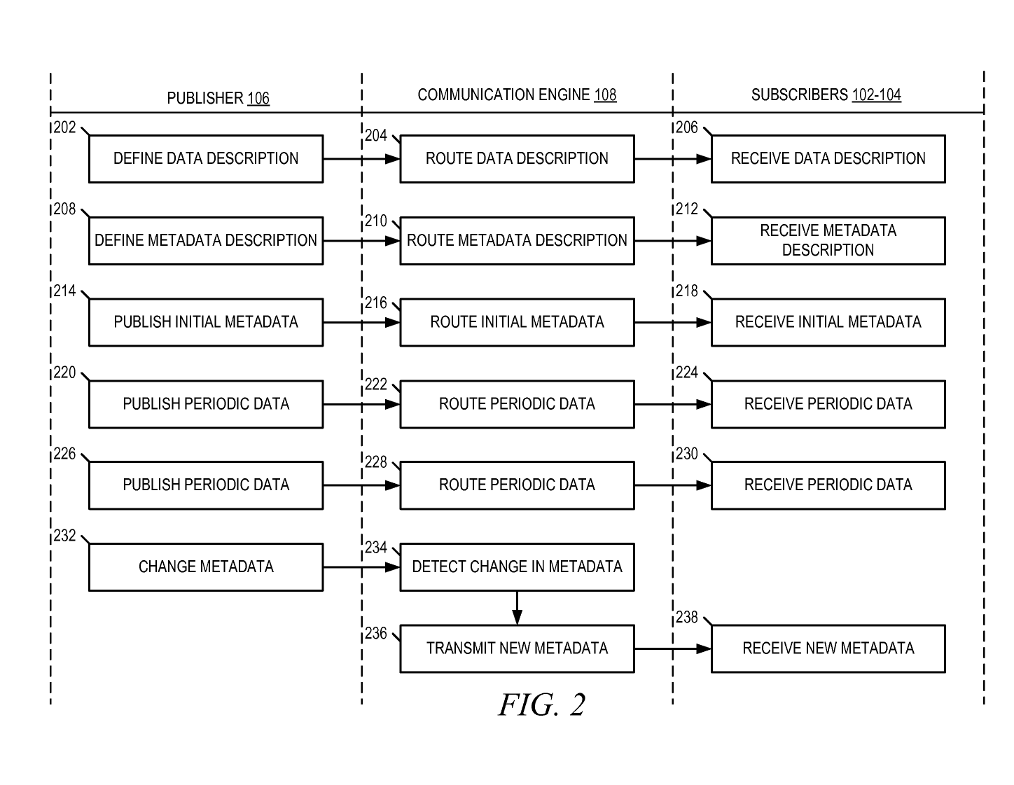

FIG. 2 is an interaction diagram depicting example exchanges between the subscribers 102-104, the communication engine 108, and the publisher 106, consistent with some embodiments. The description of a portion of these exchanges may include example code or pseudo code samples. It shall be appreciated that references to such code or pseudo code samples are not intended to limit the scope of this disclosure, but rather these code and pseudo code samples are provided merely as illustrative examples to facilitate a better understanding of the inventive subject matter.

As shown, the process begins at operation 202 with a description of periodic data to be published being defined at the publisher 106. The data description may, for example, be defined by an application administrator or implementer via an interface of the publisher 106. The data description defines the structure and type of the data being sent (e.g., “unsigned int InputValue”). For example, in an XML based protocol the data description may correspond to the XML schema. At operation 204, the communication engine 108 routes the data description to the subscribers 102-104, and at operation 206, the data description is received by the subscribers 102-104.

At operation 208, a metadata description is defined at the publisher 106. As with the data description, the metadata description may be defined by an application administrator or implementer via an interface of the publisher 106. The metadata description defines the structure and type of the metadata that describes the periodic data (e.g., “string UOM” or “string Scale”). For example, in an XML protocol this would be the schema for the XML. At operation 210, the communication engine 108 routes the metadata description to the subscribers 102-104, and at operation 212, the metadata description is received by the subscribers 102-104.

At operation 214, the publisher 106 publishes initial metadata. For example, the metadata description may define the metadata as a string corresponding to a unit of measurement (e.g., “string UOM”), and the publisher 106 may publish the initial metadata to specify that the unit of measurement is “mm/s” (e.g., “UOM=‘mm/s’”). At operation 216, the communication engine 108 routes a first data packet (e.g., a first message) including the initial metadata to the subscribers 102-104 using a first topic, and at operation 218, the first data packet is received by the subscribers 102-104.

At operation 220, the publisher 106 publishes a first set of periodic data. Following the example above, the publisher 106 may produce a value corresponding to the unit of measured defined by the metadata (e.g., “InputValue=55”). At operation 222, the communication engine 108 routes a second data packet (e.g., a second message) that includes the first set of periodic data to the subscribers 102-104 using a second topic, and at operation 224, the first set of periodic data is received by the subscribers 102-104.

As shown, the operations 220-224 are repeated in operations 226-230. That is, the publisher 106 publishes further periodic data (e.g., “InputValue=56”) that is provided to the subscribers 102-104 using the second topic. Further, these additional iterations involve publishing, routing, and receiving a second set of period data using a third data packet. It shall be appreciated that during operations 220-230 no metadata is provided to the subscribers 102-104, as the metadata has not changed. Accordingly, the periodic data involved in operations 220-230 is associated with the initial metadata set at operation 214.

At operation 232, the publisher 106 changes the metadata. Following the above examples, the publisher 106 may change the unit of measure from “mm/s” to “ft/s” (e.g., “UOM=‘ft/s’”). The change to metadata may, in some embodiments, be based on or be the result of user input. For example, the publisher 106 may correspond to a temperature probe that is initially set to produce temperature values in Celsius, but a user may switch the temperature probe to produce temperature values in Fahrenheit.

In response to detecting the change in metadata (at operation 234), the communication engine 108 generates an additional data packet (e.g., a message) for the new metadata to provide to the subscribers 102-104 using the first topic, at operation 236. Because the metadata topic is created and managed by the communication engine 108, the process may be completely transparent to the application implementer (e.g., at the publisher 106). The additional data packet comprising the new metadata is received by the subscribers 102-104 at operation 238. The publisher 106 may subsequently continue to publish periodic data, and such periodic data will continue to be provided to the subscribers 102-104 using a topic that is separate from the topic used to provide the metadata to the subscribers 102-104. Further, the subsequently published periodic data will be associated with the new metadata instead of the initial metadata. In this way, the publisher-subscriber system 100 accounts for the changes that occur at the publisher 106 and provides synchronized periodic data to the subscriber 102-104 without ambiguity.

While FIG. 2 depicts the operations 202-238 as being executed serially in a particular order, other orders of execution, including parallel, concurrent, or overlapping execution of one or more of the operations 202-238, are possible. For example, the defining of the data description (operation 202) and the defining of the metadata description (operation 208) may be performed in an overlapping, parallel, or concurrent manner on different processors or processing threads.

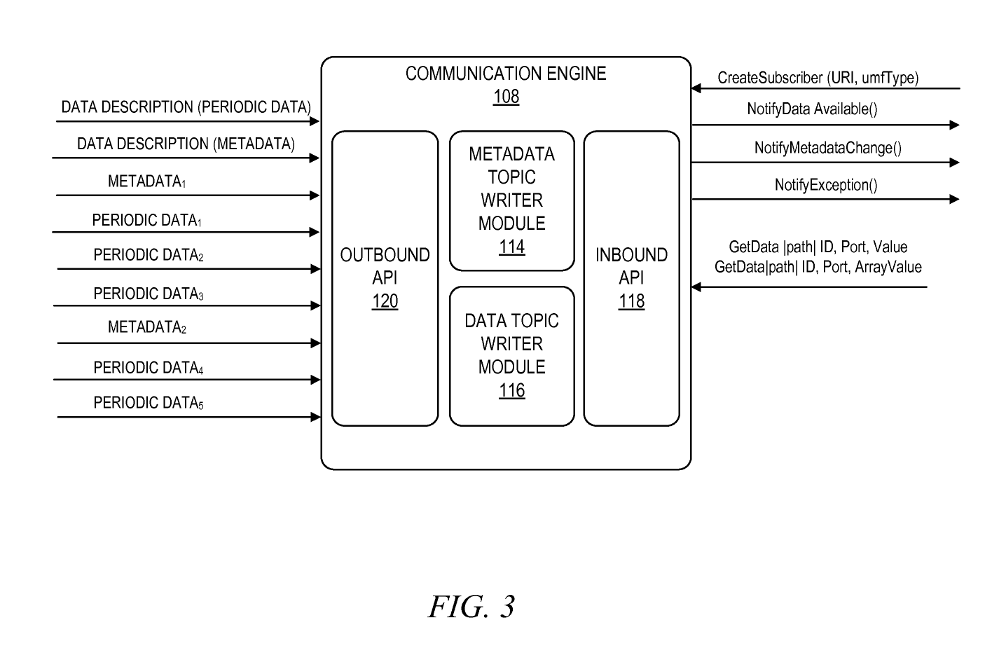

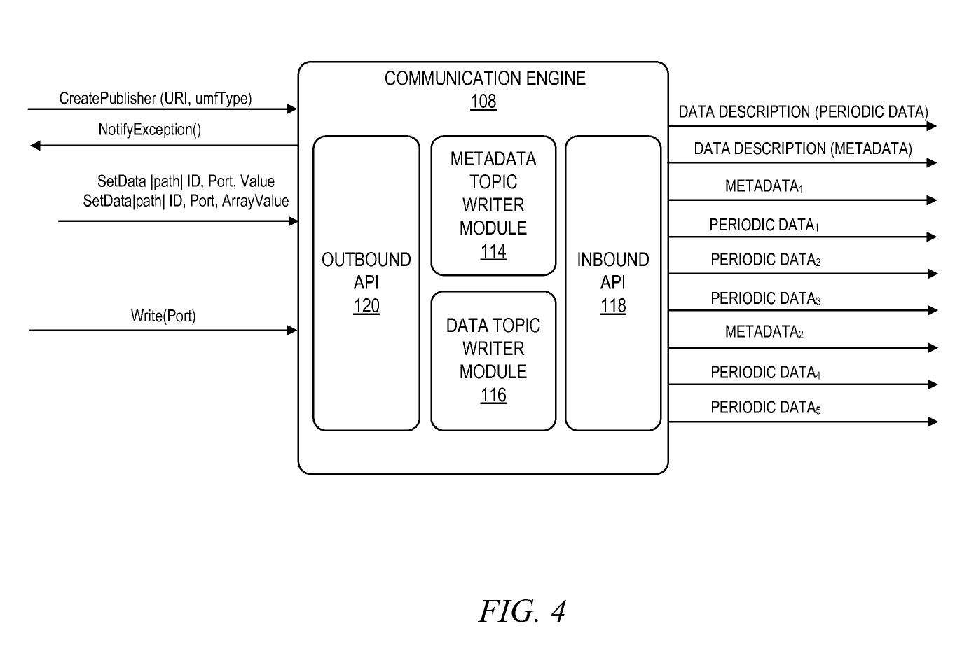

FIG. 3 and FIG. 4 are data flow diagrams respectively illustrating the inbound flow and the outbound flow of information to various components comprising the communication engine 108, which is provided as part of the publisher-subscriber system 100, consistent with some embodiments. The various components comprising the communication engine 108 are described below with reference to the inbound and outbound flow of information respectively illustrated by FIG. 3 and FIG. 4.

The communication engine 108 is responsible for management of publishers and subscribers and message routing. Accordingly, the communication engine 108 includes a metadata topic writer module 114, a data topic writer module 116, an inbound API 118, and an outbound API 120, which are all configured to communicate with each other and exchange data (e.g., via a bus, shared memory, a switch, or APIs).

The metadata topic writer module 114 is responsible for writing and routing metadata to the subscribers 102-104 based on information received from the publisher 106. For example, as shown in FIG. 3, the communication engine 108, specifically the metadata topic writer module 114, receives a metadata description and multiple sets of metadata (e.g., “Metadata₁” and “Metadata₂”) from the publisher 106 (not shown). The metadata is descriptive data that describes periodic data produced by the publisher 106.

As illustrated in FIG. 4, the metadata topic writer module 114 sends metadata to the subscribers 102-104 using a dedicated topic that is separate and distinct from the topic used by the data topic writer module 116 to send the periodic data. At the onset of a communication session (e.g., a period of time in which the publisher 106 exchanges data with the subscribers 102-104), the metadata topic writer module 114 may write an initial data packet to the metadata topic that comprises the metadata description and another data packet that comprises initial metadata (e.g., “Metadata₁”) associated with periodic data produced by the publisher 106. Thereafter, the metadata topic writer module 114 writes metadata to the metadata topic only upon detecting changes to the metadata. For example, as shown in FIG. 4, the metadata topic writer module 114 writes the “Metadata₂” to the metadata topic only after determining that the metadata has changed from “Metadata₁” to “Metadata₂”. Subsequent periodic data provided by the data topic writer module 116 is associated with the new metadata (e.g., “Metadata₂”).

The data topic writer module 116 is responsible for writing and routing periodic data to the subscribers 102-104 based on information received from the publisher 106. For example, as shown in FIG. 3, the communication engine 108, specifically the data topic writer module 116, receives and routes a periodic data description and multiple sets of periodic data (e.g., “Periodic Data₁”-“Periodic Data₅”) from the publisher 106 (not shown) to the subscribers 102-104 (not shown). The periodic data is the data that is periodically produced and published by the publisher 106.

As illustrated in FIG. 4, the data topic writer module 116 sends the periodic data in a dedicated topic that is separate and distinct from the topic used by the metadata topic writer module 114 to send the metadata. For example, the data topic writer module 116 sends the “Periodic Data₁”-“Periodic Data₅” in multiple messages using a separate topic from the topic used by the metadata topic writer module 114 to send the “Metadata₁” and “Metadata₂.” By sending the metadata and the periodic data using separate topics, the communication engine 108 allows the publisher-subscriber system 100 to adapt to the nature of data loads produced by the publisher 106 and thereby increases the efficiency of network bandwidth use.

The inbound API 118 is configured to interface with the subscribers 102-104. Accordingly, as shown in FIG. 3, the inbound API 118 may receive requests to create subscribers to data of a particular type produced by a particular data source (e.g., the publisher 106). Such requests may specify the type of data (indicated in FIG. 3 by “umfType”) and a uniform resource identifier (URI) that identifies the data source (e.g., the publisher 106). The inbound API 118 may further provide a number of notifications to the subscribers 102-104. For example, when new data is produced, the inbound API 118 may provide a notification that new periodic data is available. As another example, when metadata has changed, the inbound API 118 may provide a notification that the metadata has changed. In yet another example, the inbound API 118 may provide notifications of exceptions or errors related to the exchange of data within the publisher-subscriber system 100.

The outbound API 120 is configured to interface with the publisher 106. Accordingly, as shown in FIG. 4, the outbound API 120 may receive requests to create new publishers. Such requests may specify a type of data (indicated in FIG. 4 by “umfType”) produced by the publisher and a URI corresponding to the publisher. The outbound API 120 may further provide exception notifications to the publisher related to the exchange of data within the publisher-subscriber system 100.

As is understood by skilled artisans in the relevant computer and Internet-related arts, each component (e.g., a module or engine) illustrated in FIG. 3 and FIG. 4 represents a set of executable software instructions and the corresponding hardware (e.g., memory and processor) for executing the instructions. Further, it shall be appreciated that while the components of FIG. 3 and FIG. 4 are discussed in the singular sense, in other embodiments multiple instances of one or more of the modules may be employed. Moreover, it shall be appreciated that one or more of these various components of the communication engine 108 may be combined into a single component. For example, in some embodiments, the inbound API 118 and the outbound API 120 may be combined into a single API configured to provide the functionality of both the inbound API 118 and the outbound API 120. Additionally, while FIGS. 3 and 4 depict the inbound API 118, outbound API 120, metadata topic writer module 114, and data topic writer module 116 as forming part of the communication engine 108, in shall be appreciated that in other embodiments the inbound API 118, outbound API 120, metadata topic writer module 114, and data topic writer module 116 may be implemented as stand-alone components that are independent of the communication engine 108.

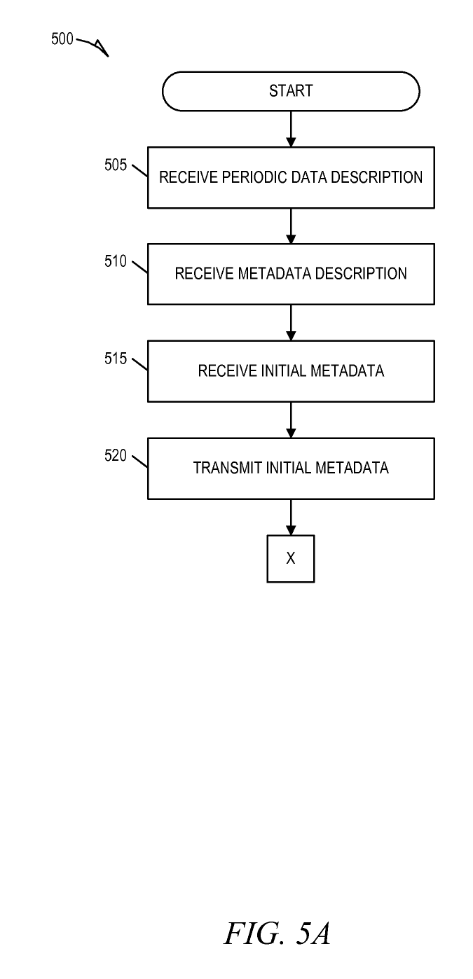

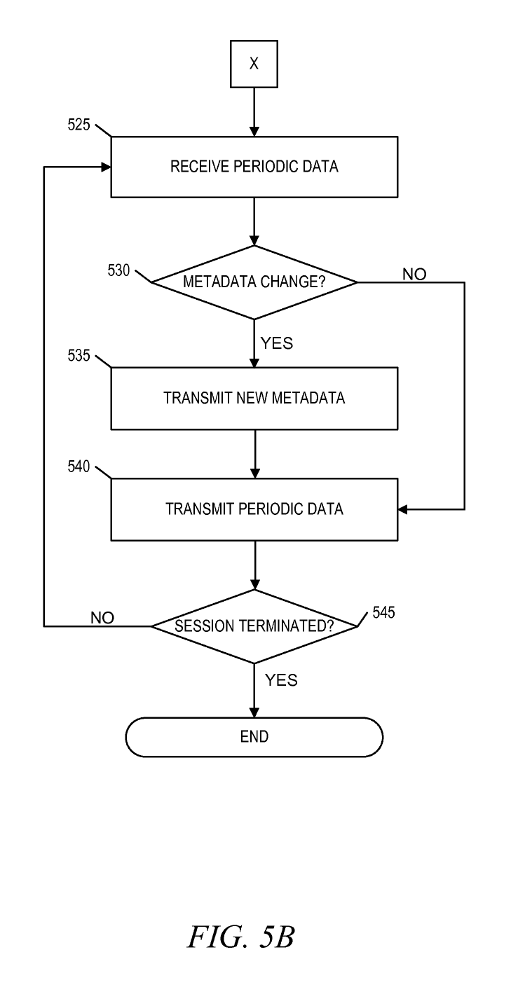

FIGS. 5A and 5B depict a flowchart of a method 500 for managing metadata in a high volume real-time data stream, consistent with some embodiments. The method 500 may be embodied in computer-readable instructions for execution by one or more processors such that the steps of the method 500 may be performed in part or in whole by the components of the communication engine 108, and accordingly, the method 500 is described below by way of example with reference thereto. However, it shall be appreciated that the method 500 may be deployed on various other hardware or software configurations and is not intended to be limited to the communication engine 108.

At operation 505, the data topic writer module 116 receives a data description from the publisher 106. The data description defines a structure and type of periodic data that will be produced by the publisher 106. For example, the data description received from the publisher 106 may define the periodic data as an unsigned integer.

At operation 510, the metadata topic writer module 114 receives a metadata description from the publisher 106. The metadata description defines a structure and type of the metadata that describes the periodic data. For example, the metadata description received from the publisher 106 may define the metadata as a string that corresponds to a unit of measurement or a scale.

At operation 515, the metadata topic writer module 114 receives initial metadata published by the publisher 106. For example, the initial metadata may set the unit of measurement for the periodic data to be “mm/s”. At operation 520, the metadata topic writer module 114 transmits a data packet comprising the initial metadata to the subscribers 102-104 using a first topic (hereinafter referred to as the “metadata topic”).

Turning to FIG. 5B, at operation 525, the communication engine 108 receives periodic data produced by the publisher 106. In an example, the subscribers 102-104 may correspond to an image-consuming application and the publisher 106 may correspond to a camera or other device with embedded image-capturing capability. In this example, the periodic data produced by the publisher 106 is image data.

At operation 530, the metadata topic writer module 114 determines whether the metadata associated with the periodic data has changed. In some embodiments, the metadata topic writer module 114 may determine whether a change in the metadata has occurred by comparing the current metadata associated with the periodic data with previous metadata (e.g., the initial metadata). The change in metadata may, for example, be based on or in response to user input.

If the metadata topic writer module 114 determines that the metadata set by the publisher 106 has changed, the method 500 proceeds to operation 535, where the metadata topic writer module 114 transmits an additional data packet comprising the new metadata to the subscribers 102-104 using the metadata topic. In this way, the metadata topic writer module 114 causes synchronization of the periodic data and associated metadata produced by the publisher and received by the subscribers. In some embodiments, in response to the change in metadata being detected, the communication engine 108 may transmit a notification to the subscribers 102-104 to notify the subscribers 102-104 of the change to the metadata. At operation 540, the data topic writer module 116 routes the periodic data in a data packet using a second topic (referred to hereinafter as the “data topic”). If the metadata topic writer module 114 determines that the metadata set by the publisher 106 has not changed, the method 500 proceeds directly to operation 540 without sending new metadata to the subscribers 102-104.

At operation 545, if the communication session has terminated (e.g., if the publisher 106 is no longer producing data) the method 500 terminates. If the communication session has not terminated, the method 500 returns to operation 525. In other words, as long as the publisher 106 continues to produce periodic data, the communication engine 108 will continue to provide the subscribers 102-104 with the periodic data using the data topic. Further, the metadata associated with the periodic data is transmitted upon being initially set, and subsequently, only when it changes.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field-programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site, or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Machine Architecture and Machine-Readable Medium

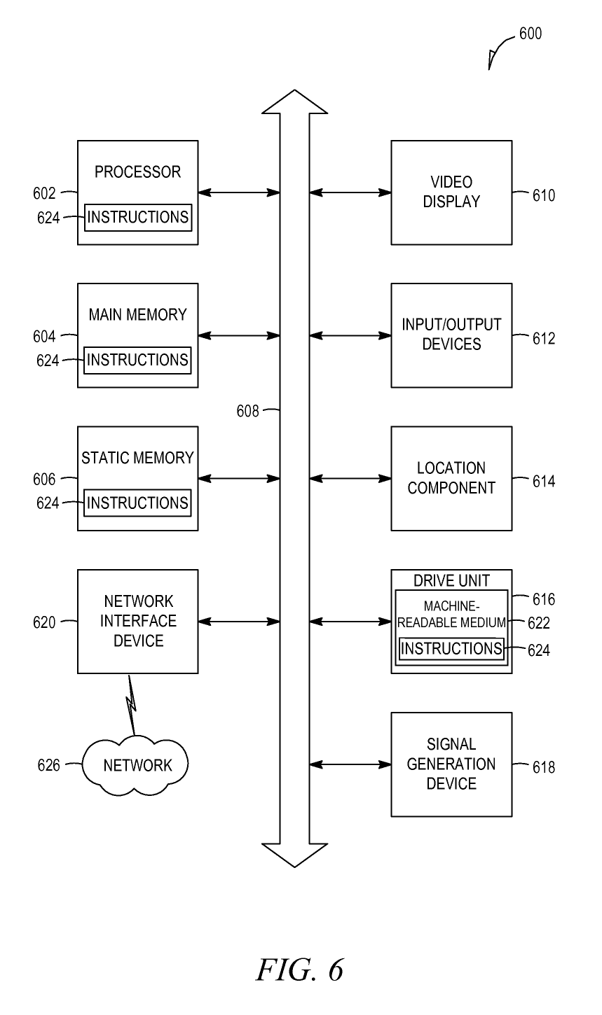

FIG. 6 is a diagrammatic representation of a machine in the example form of a computer system 600 within which a set of instructions for causing the machine to perform any one or more of the methodologies discussed herein may be executed. The computer system 600 may correspond to any of the subscribers 102-104, the publisher 106, or the communication engine 108, consistent with some embodiments. The computer system 600 may include instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a PDA, a cellular telephone, a smart phone (e.g., iPhone®), a tablet computer, a web appliance, a handheld computer, a desktop computer, a laptop or netbook, a set-top box (STB) such as provided by cable or satellite content providers, a wearable computing device such as glasses or a wristwatch, a multimedia device embedded in an automobile, a Global Positioning System (GPS) device, a data enabled book reader, a video game system console, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU), or both), a main memory 604, and a static memory 606, which communicate with each other via a bus 608. The computer system 600 may further include a video display 610 (e.g., a liquid crystal display (LCD) or a cathode ray tube (CRT)). The computer system 600 also includes one or more input/output (I/O) devices 612, a location component 614, a drive unit 616, a signal generation device 618 (e.g., a speaker), and a network interface device 620. The I/O devices 612 may, for example, include a keyboard, a mouse, a keypad, a multi-touch surface (e.g., a touchscreen or track pad), a microphone, a camera, and the like.

The location component 614 may be used for determining a location of the computer system 600. In some embodiments, the location component 614 may correspond to a GPS transceiver that may make use of the network interface device 620 to communicate GPS signals with a GPS satellite. The location component 614 may also be configured to determine a location of the computer system 600 by using an internet protocol (IP) address lookup or by triangulating a position based on nearby mobile communications towers. The location component 614 may be further configured to store a user-defined location in the main memory 604 or the static memory 606. In some embodiments, a mobile location enabled application may work in conjunction with the location component 614 and the network interface device 620 to transmit the location of the computer system 600 to an application server or third party server for the purpose of identifying the location of a user operating the computer system 600.

In some embodiments, the network interface device 620 may correspond to a transceiver and antenna. The transceiver may be configured to both transmit and receive cellular network signals, wireless data signals, or other types of signals via the antenna, depending on the nature of the computer system 600.

### Machine-Readable Medium

The drive unit 616 includes a machine-readable medium 622 on which is stored one or more sets of data structures and instructions 624 (e.g., software) embodying or used by any one or more of the methodologies or functions described herein. The instructions 624 may also reside, completely or at least partially, within the main memory 604, the static memory 606, and/or the processor 602 during execution thereof by the computer system 600, with the main memory 604, the static memory 606, and the processor 602 also constituting machine-readable media.

Consistent with some embodiments, the instructions 624 may relate to the operations of an operating system (OS). Depending on the particular type of the computer system 600, the OS may, for example, be the iOS® operating system, the Android® operating system, a BlackBerry® operating system, the Microsoft® Windows® Phone operating system, Symbian® OS, or webOS®. Further, the instructions 624 may relate to operations performed by applications (commonly known as “apps”), consistent with some embodiments. One example of such an application is a mobile browser application that displays content, such as a web page or a user interface using a browser.

While the machine-readable medium 622 is shown in an example embodiment to be a single medium, the term “machine-readable medium” may include a single medium or multiple media (e.g., a centralized or distributed database, and/or associated caches and servers) that store the one or more data structures or instructions 624. The term “machine-readable medium” shall also be taken to include any tangible medium that is capable of storing, encoding, or carrying instructions (e.g., instructions 624) for execution by the machine and that cause the machine to perform any one or more of the methodologies of the present disclosure, or that is capable of storing, encoding, or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

Furthermore, the tangible machine-readable medium is non-transitory in that it does not embody a propagating signal. However, labeling the tangible machine-readable medium “non-transitory” should not be construed to mean that the medium is incapable of movement—the medium should be considered as being transportable from one real-world location to another. Additionally, since the machine-readable medium is tangible, the medium may be considered to be a machine-readable device.

### Transmission Medium

The instructions 624 may further be transmitted or received over a network 626 using a transmission medium. The instructions 624 may be transmitted using the network interface device 620 and any one of a number of well-known transfer protocols (e.g., HTTP). Examples of communication networks include a LAN, a WAN, the Internet, mobile telephone networks, plain old telephone service (POTS) networks, and wireless data networks (e.g., WiFi and WiMax networks). The term “transmission medium” shall be taken to include any intangible medium that is capable of storing, encoding, or carrying the instructions 624 for execution by the machine, and includes digital or analog communications signals or other intangible media to facilitate communication of such software.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim.

What is claimed is:

1. A method comprising:
transmitting an initial data packet comprising metadata, the metadata describing periodic data, the periodic data being data periodically published by a publisher;
transmitting one or more additional data packets comprising the periodic data;
detecting a change to the metadata; and
in response to detecting the change to the metadata, transmitting a further data packet comprising new metadata.

2. The method of claim 1, further comprising:
receiving a first data description, the first data description defining a data type for the periodic data; and
receiving a second data description, the second data description defining one or more parameters of the metadata.

3. The method of claim 1, further comprising transmitting subsequent data packets comprising further periodic data, the subsequent data packets being transmitted subsequent to the transmitting of the further data packet.

4. The method of claim 3, wherein the further periodic data is associated with the new metadata.

5. The method of claim 1, further comprising transmitting a notification of the change to the metadata.

6. The method of claim 1, further comprising:
obtaining the periodic data and the metadata from the publisher;
generating the initial data packet using the metadata; and
generating the one or more additional data packets using the periodic data.

7. The method of claim 1, wherein the transmitting of the initial data packet includes routing the initial data packet to a subscriber of data published by the publisher.

8. The method of claim 1, wherein the initial data packet and the further data packet are transmitted using a first logical channel, and wherein the one or more additional data packets are transmitted using a second logical channel.

9. The method of claim 1, wherein the transmitting of the further data packet synchronizes the periodic data published by the publisher with periodic data received by one or more subscribers.

10. The method of claim 1, wherein the change to the metadata is in response to user input.

11. The method of claim 1, wherein the detecting the change to the metadata is based on a comparison of current metadata with the metadata transmitted in the initial data packet.

12. A system comprising:
one or more processors configured to include:
a data topic writer module configured to transmit one or more data packets comprising periodic data, the periodic data being data periodically published by a publisher; and
a metadata topic writer module configured to transmit an initial data packets comprising metadata, the metadata describing the periodic data, the metadata topic writer module further configured to detect a change to the metadata, the metadata topic writer module further configured to transmit an additional data packet comprising new metadata in response to detecting the change to the metadata.

13. The system of claim 12, wherein the data topic writer module is further configured to transmit a further data packet comprising further periodic data, the further periodic data being associated with the new metadata.

14. The system of claim 12, wherein the metadata topic writer module is further configured to transmit the initial data packet and the additional data packet using a first logical channel, and wherein the data topic writer module is further configured to transmit the one or more data packets using a second logical channel.

15. The system of claim 12, further comprising an application programming interface (API) configured to receive a subscription request for the periodic data, the subscription request including an identifier of a subscriber.

16. The system of claim 12, wherein the data topic writer module is configured to transmit the one or more data packets by routing the one or more data packets to the subscriber based on the subscriber being subscribed to the periodic data.

17. The system of claim 15, wherein the API is further configured to provide a notification of the change to the metadata.

18. The system of claim 12, wherein the data topic writer module is further configured to receive a data description of the periodic data, the data description defining a data type and structure of the periodic data.

19. The system of claim 12, wherein the metadata topic writer module is further configured to receive a data description of the metadata, the data description of the metadata defining one or more aspects of the metadata.

20. A non-transitory machine-readable storage medium embodying instructions that, when executed by at least one processor of a machine, cause the machine to perform operations comprising:
transmitting an initial data packet comprising metadata, the metadata describing periodic data, the periodic data being data periodically published by a publisher;
transmitting one or more additional data packets comprising the periodic data;
detecting a change to the metadata; and
in response to detecting the change to the metadata, transmitting a further data packet comprising new metadata.
